(19) United States
(12) Patent Application Publication
(10) Pub. No.: US 2022/0232951 A1
(43) Pub. Date: Jul. 28, 2022

(54) INTERACTIVE STORAGE SYSTEM, APPARATUS, AND RELATED METHODS

(71) Applicant: Gil Joseph Laks, Las Vegas, NV (US)

(72) Inventor: Gil Joseph Laks, Las Vegas, NV (US)

(21) Appl. No.: 17/584,109

(22) Filed: Jan. 25, 2022

Related U.S. Application Data
(60) Provisional application No. 63/142,768, filed on Jan. 28, 2021.

(51) Int. Cl. A45D 44/00; G06T 19/20; G06T 19/00; G06K 7/14

(52) U.S. Cl. CPC A45D 44/005; G06T 19/20; G06T 2219/2012; G06K 7/1417; A45D 2044/007; G06T 19/006

(57) ABSTRACT

The systems, devices, and methods described herein relate to an interactive storage and identification system for storage and efficient, accurate identification of items, such as cosmetic items. The interactive storage and identification system can include a number of compartments as well as a display that is coupled to the storage system via a wireless/remote or a direct physical connection. The interactive storage and identification system can be configured to receive a selection of a compartment and/or item from a user, and upon receiving the selection, display an image of the shade and texture of the item and the user with the selected item applied to his/her face.

### RELATED APPLICATIONS

This application claims the benefit of and priority to U.S. Provisional Application No. 63/142,768 filed on Jan. 28, 2021. The entire teachings of this earlier application is incorporated herein by reference.

### FIELD

The present disclosure generally relates to an interactive storage and identification system and apparatus, and more particularly to an interactive storage and identification system for storage of various items, such as cosmetics.

### BACKGROUND

The cosmetic industry often provides consumers with a wide range of options. For example, numerous companies make and manufacture commonly used cosmetic items, such as lipsticks and eye shadows. Often times, these items are marketed in various shades and textures are easily identified in the store, however once purchased, these items are often packaged in the same way without clear identifying marks, as they often have the same packaging, same shape, same color and similar markings). Although color guides that show the shade and texture of such items are often available at the time of purchase, many consumers can feel that they cannot easily differentiate between the similar packages and/or be certain as to how a shade or texture would appear on their face/skin until they have actually located and applied the product to their face/skin.

Often times, when trying cosmetics and beauty products, an individual may wish to try various shades and select one depending on various factors such as skin tone, clothing, mood, occasion, etc. For example, a person may own many lipsticks in various shades of red and would like to wear red lipstick to function such as party or a job interview. That individual may feel that a certain shade of red is appropriate for attending a party but not necessarily for a job interview. In order to select the desired lipstick, the individual will need to spend time locating, opening and possibly applying different products before the selection is finalized. If an incorrect shade is applied, it can takes even more time to remove, re-select and re-apply the lipstick. This process is often done in a rush and can be non-systematic and stressful. Further, re-application can often ruin the final outcome of makeup appearance.

Further, some cosmetic manufacturers and retail shops have tried to facilitate makeup selection process by offering samples and makeovers to their clients and customers. The samples are offered in the store, where a potential buyer can apply and see the cosmetic against their skin. However, this process is not always ideal because it can require applying the new makeup over existing makeup and/or removal of existing makeup so that the new makeup can be applied. Further, this process is not always hygienic because often times, a single applicator is shared by all interested customers. For example, a single tube of lipstick can be made available, allowing customers to decide, depending on their individual comfort level, whether they would like to apply the lipstick directly to their lips, test on their hands, use a single-use applicator to apply to their lips, open the tube to see the color, etc. This process can result in many unnecessary touch points that facilitates transmission of microbes and viruses among the consumers.

### SUMMARY

The systems, devices, and methods described herein relate to an interactive storage and identification system for storage and identification of items, such as cosmetic items, that can be used by a consumer at home, while traveling, or in other desired locations. The interactive storage and identification system can include a number of compartments as well as a display screen that is coupled to the storage and identification system via a wireless/remote or a direct physical connection. The interactive storage and identification system is configured to receive a selection of a compartment and/or item from a user, and upon receiving the selection, display an image of the item and/or information about a property of the item, such as that the shade and/or texture of the item, and in addition can display an image of the user with the selected item applied to his/her body, e.g., the face. For example, upon identification and selection of a crimson shade of lipstick, the display screen can identify and display an image of the user with the particular shade of crimson lipstick applied to his/her lips promoting efficiency in identification, selection, while providing a less stressful and more accurate process with potentially reduced transmission of microbes, especially when used in a commercial environment.

In one aspect, a storage system for identifying and storing various items is disclosed. The storage system provides a systematic storage for storing items according to different classifications (e.g., color, brand, etc.), thereby facilitating use and organization of the items. The storage system can comprise a display configured to display a stored item upon selection by a user. The display can be configured to display the selected item transposed, added, and/or stitched to another image, for example on an image of the user.

In one aspect, a system comprising a housing configured to house a plurality of cosmetic items is disclosed. The housing can comprise a plurality of compartments each configured to house a cosmetic item. The system includes one or more processors programmed to execute instructions for selecting and displaying to a user one or more items in a compartment, so the user can identify how a cosmetic would appear when worn on the user. The one or more processors may be coupled to the housing and include a memory coupled to the one or more processors, with one or more programs stored in the memory and configured to be executed by the one or more processors. In certain adaptations, the one or more programs include instructions that upon execution by the one or more processors receive a selection of at least one cosmetic item from a user and forward identification information regarding the at least one cosmetic item to a display screen configured to display an updated image showing the at least one cosmetic item applied to at least one appropriate portion of a face of the user.

In other examples, the aspects above, or any system, method, apparatus described herein can include one or more of the following features.

The housing can be configured to house the display screen, and the display screen can be coupled to the housing via at least one of a mechanical connection and a wireless connection.

In some implementations, the plurality of compartments can comprise at least one sensor configured to identify the cosmetic item housed in the compartment. The at least one sensor can include a barcode reader configured to identify a barcode of the cosmetic item housed in the compartment. Further, the at least one sensor can be configured to be activated in response to actuation or other selection of the cosmetic item within the compartment. Once activated, the at least one sensor can be configured to forward the identification information, obtained from identifying the cosmetic item, to the processor. The identification information indicates selection of the cosmetic item by the user and may include at least one of information indicating type of the at least one cosmetic item, information indicating at least one feature of the at least one cosmetic item, and information identifying the at least one appropriate portion of the face of the user. The information identifying the at least one portion of the face can be used to identify a specific portion (e.g., eye lids or lips), where the cosmetic item is typically applied. In various implementations, the at least one feature includes at least one of: color, shade, texture, and tone of the at least one cosmetic item, and the at least one appropriate portion of the face of the user comprises at least one of cheeks, eyelids, and lips of the user.

The plurality of cosmetic items can include at least one of lipstick, lip-color, lip-gloss, lip-liner, foundation, powder, eyeliner, eye shadow, cheek color, blush, and mascara. Additionally or alternatively, the cosmetic items can comprise an item of jewelry.

Further, the plurality of compartments can be configured to removably and/or interchangeably house the plurality of cosmetic items.

In some implementations, the display screen can comprise a digital mirror or a digital camera configured to display a photo and/or a video of the user in real-time. Further, in some embodiments, the system can comprise a lid configured to removably close and seal the housing. The lid can comprise an internal surface configured to house the display screen and can, in some implementations, comprise at least one LED lamp disposed on internal perimeter thereof. Generally, the display screen can be included in any suitable position in the system. For example, the display screen can be separate from the storage system and/or be the display screen of another device (e.g., the display screen of a mobile phone). Further, the lid can comprise a camera configured to obtain an image of the user and display the image on the display screen.

Other aspects and advantages of the invention can become apparent from the following drawings and description, all of which illustrate the various aspects of the invention, by way of example only.

### BRIEF DESCRIPTION OF THE DRAWINGS

The foregoing and other objects and advantages will be apparent upon consideration of the following detailed description, taken in conjunction with the accompanying drawings, in which like reference characters refer to like parts throughout, and in which:

FIG. 1 schematically illustrates a high-level diagram of a system for storing items according to some embodiments disclosed herein;

FIG. 2 schematically illustrates a high-level diagram of a portion of a system for storing items according to some embodiments disclosed herein;

FIG. 3 is a high-level block diagram of a system for storing items according to some embodiments disclosed herein;

FIG. 4 is another high-level block diagram of a system for storing items according to some embodiments disclosed herein;

FIG. 5 is yet another high-level block diagram of a system for storing items according to some embodiments disclosed herein;

FIG. 6 is a high-level block diagram of a compartment that can be used in a storage system according to some embodiments disclosed herein.

FIG. 7 is a flow diagram of some of the procedures that can be carried out by the interactive storage system according to some embodiments disclosed herein.

### DETAILED DESCRIPTION

The present disclosure generally relates to an interactive storage system and apparatus, and, more particularly, to systems, apparatus, and corresponding methods for interactive storage of a variety of items, such as cosmetics.

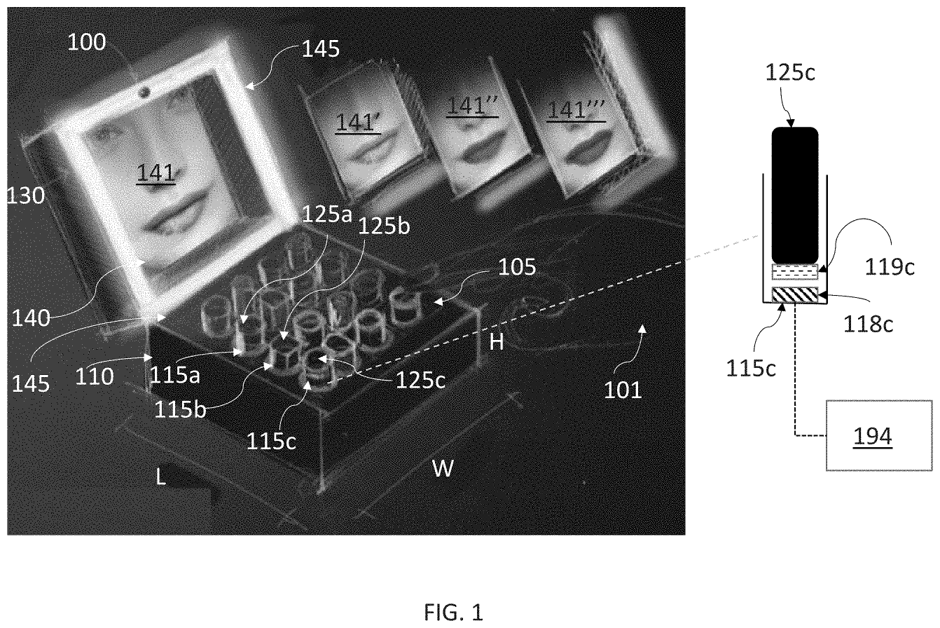

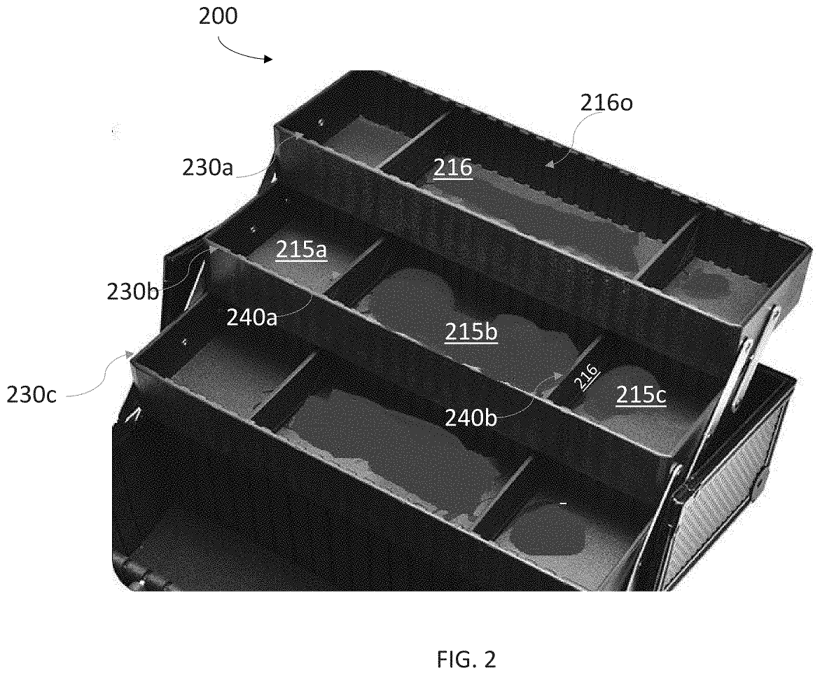

FIG. 1 schematically illustrates an example of an interactive storage system 100 (hereinafter “storage system”) according to some embodiments disclosed herein. The storage system 100 can comprise a housing 110 having at least one hollow portion 105 configured to house one or more compartments 115a, 115b, 155c. Each of the one or more compartments 115a, 115b, 155c can be configured to extend along at least a portion of length (L), width (W), and/or height (H) of the housing such that they define a cavity 216 (shown in FIG. 2) having an opening 216o configured to receive at least one item 125a, 125b, 125c.

The at least one item 125a, 125b, 125c can generally be any suitable item. For example, in some implementations, the at least one item 125a, 125b, 125c can be an item of cosmetics (e.g., lipstick, lip-color, lip-gloss, lip-liner, foundation, powder, eyeliner, eye shadow, cheek color, blush, mascara, etc.). The at least one item can be enclosed in any suitable packaging or housing available in the relevant art.

The housing 110 can comprise any suitable size, shape, and material known and available in the relevant art. For example, the housing 110 can comprise at least one of: a polymeric material (e.g., Acrylonitrile Butadiene Styrene (ABS), Polyvinyl Chloride, Poly(methyl methacrylate) or Acrylic Plastic, etc.), any suitable metal (e.g., aluminum), natural wood, any suitable fabric, etc.

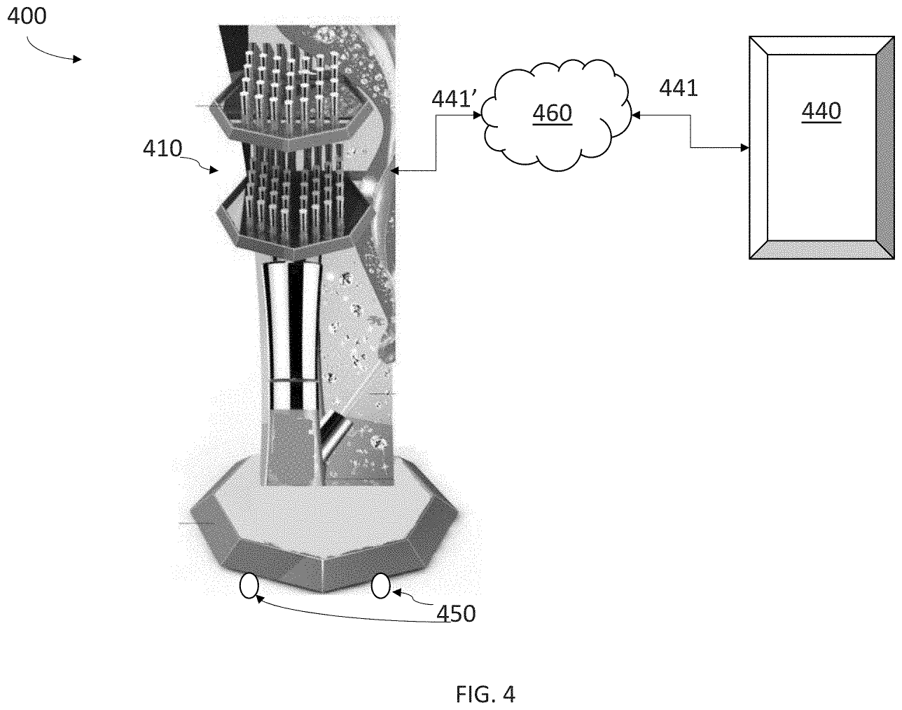

The housing 110 can further comprise any shape or size. For example, the housing can be box-shaped and/or be cylindrical (e.g., hat-box shaped). Further, although shown as having a single layer of compartments, the housing 110 can comprise one or more layers of compartments. For example, as shown in FIG. 2, which schematically illustrates a partial view of the storage system according to some implementations disclosed herein, the storage system 200 can comprise one or more trays 230a, 230b, 230c, each having one or more compartments 215a, 215b, 255c each configured to hold at least one item. Additionally or alternatively, the housing can comprise one or more shelves, such as display shelves commonly used at cosmetic retailers (as shown in FIG. 4).

The compartments 215a, 215b, 215c can be adjustable to allow insertion of items having various shapes and sizes. For example, each tray 230b can comprise one or more dividers 240a, 240b configured to form at least one wall 216 of a corresponding compartment 215b, 215c. The dividers can be removable, replaceable, and repositionable to allow the user to move, reposition, or remove any of the dividers in order to change the size of a compartment 215b, 215c.

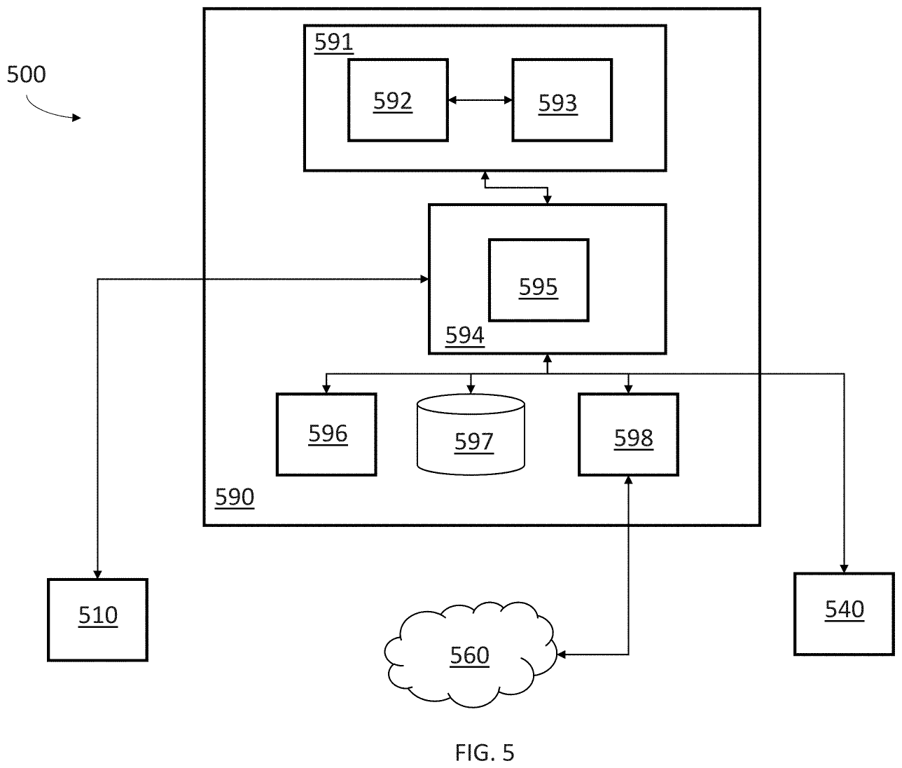

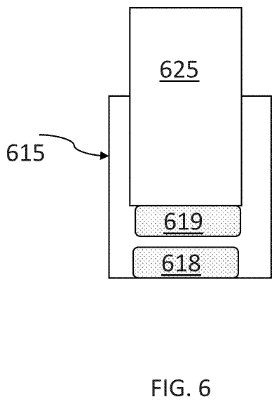

As detailed below, with reference to FIG. 6, each compartment 155c can include at least one identification mechanism 118c, such as a sensor, configured to identify the items 125c received by the compartment. The identification mechanism 118c can be any suitable mechanism or sensor available in the art, and the mechanism 118c can use any suitable technique known in the art to identify the items 125c. For example, the identification mechanism 118c can be an RFID or barcode reader configured to read a barcode or RFID tag 119c (e.g., passive RFID tag) on the item 125c and/or a sensor capable of reading and analyzing the information included on a label or a tag 119c coupled to the item 125c. The barcode 119c can include any suitable information regarding the item 115c, such as information regarding type, color, and texture of the item 625. For example, the items 125a, 125b, 125c can be various shades of lipstick (e.g., red, cherry, rose, merlot, garnet, crimson, scarlet, wine, currant, candy, etc.) produced by various manufacturers and brands. This information can be reflected on the identification tag 119c of the item 125c (e.g., on a small label indicating the specific shade, such as shade 466, or name, such as “CARMEN,” of a certain brand, such as Chanel®). The identification mechanism 118c can read this information and forward the information to a processor 194 (detailed below with reference to FIG. 5) for analysis. The processor 194, upon receiving this information, can process and present a user of the storage system 100 with identifying information regarding the item 125c. For example, the processor 194 can direct the display 140 to display some information regarding the item 125c (e.g., information pertaining to the name and shade of the item 125c) and/or present the user with an updated image of the user showing the item transposed on an appropriate portion of the user's image (e.g., showing the specific shade of lipstick applied to the user's lips). Alternatively or additionally, the processor can direct an audio speaker to provide an audio signal indicating the name and/or brand of the item (e.g., play a sound indicating the user has selected shade 466, named Carmen, manufactured by Chanel®). Generally, any suitable technique available in the art can be used to relay the identifying information to the user.

Referring back to FIG. 1, the storage system 100 can further comprise a cover 130. The cover 130 can be moveably coupled to the housing 110 and configured to cover at least one portion of the hollow portion 105 of the housing 110. Alternatively, or additionally, the cover 130 can be configured to cover at least one portion of the opening 216o of a compartment 215s, 125b, 125c. The cover 130 can be configured to cover and secure the contents of the housing and compartments. For example, the cover 130 can be configured to secure the at least one items 125a, 125b, 125c from spillage and/or protect the items 125a, 125b, 125c from environmental elements, such as light, heat, dust, dirt, etc.

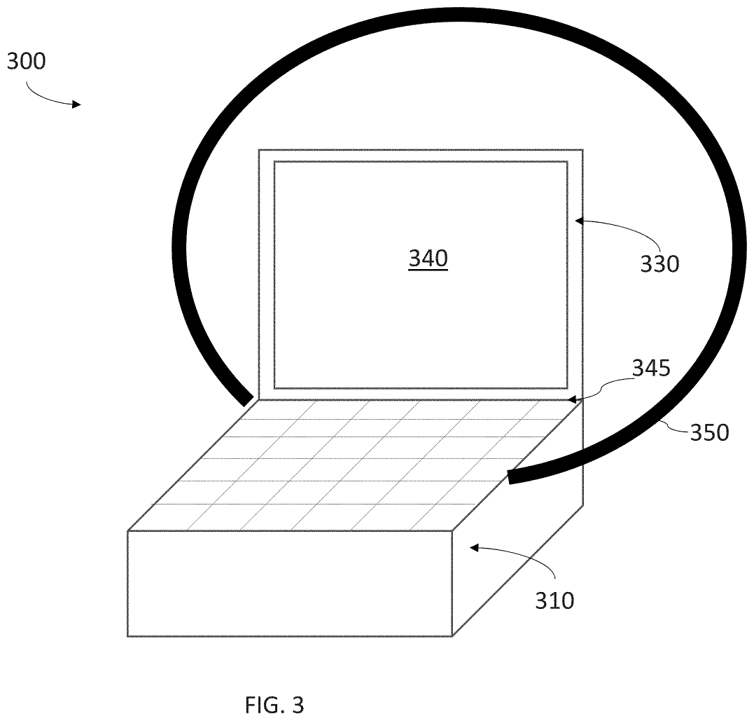

In some implementations, the cover 130 can be moveably attached to at least one portion of the housing 110. For example, as shown in FIG. 1, the cover 130 can be a flip cover that is hingedly coupled to a portion of the housing (e.g., via at least one hinge 145) and configured to be lifted and/or lowered to expose and/or cover the hollow portion of the housing. Additionally or alternatively, the cover can be slideably coupled to the housing. For example, as shown in FIG. 3, the housing 310 can comprise a rail 345 configured to slideably receive the cover 330. Generally, any suitable cover can be used with the embodiments disclosed herein, and the cover can be coupled to the housing via any suitable connection available and known in the art. Further, although the storage system is shown in FIG. 1 and FIG. 3 as including a cover, in some implementations, the storage system 100/300 can also be coverless. For example, as shown in FIG. 4, the storage system 400 can comprise one or more display shelves that remain open and exposed at the top without being covered.

Further, in some implementations, the storage system can comprise a mechanism that facilitates movement/carrying of the storage system. Generally, any suitable mechanism available in the art can be used with the embodiments disclosed herein. For example, as shown in FIG. 3, the storage system 300 can comprise at least one strap or handle 350 that can be used to carry the storage system 350. Alternatively or additionally, as shown in FIG. 4, the storage system 400 can comprise one or more wheels 450 configured to facilitate movement of the storage system 400. As noted, generally any suitable mechanism available in the art for facilitating movement and/or carrying of the system can be used.

Referring back to FIG. 1, the storage system 100 can further comprise a display 140. The display can be directly and/or indirectly coupled to the housing 110. For example, as shown in FIG. 1, the display can be integrated into the cover 130 and/or be mechanically coupled to the housing via a physical connection 145. Alternatively or additionally, the display 140 can be remotely coupled to the housing 110 using a wired or wireless connection. For example, as shown in FIG. 4, the display 440 can be positioned remote from the housing 410 and configured to connect to the housing via a network 460.

The display 140/440 can generally be any suitable display available in the art, for example a Liquid Crystal Display (LCD) or a light emitting diode (LED) display. Further, the display 140/440 can include one or more sources of light 145, such as LED lamps on its perimeter. The light sources 145 are configured to illuminate the surrounding premier of the display 140 to improve visibility. The lights 140 can serve any suitable function. For example, the lights 140 can serve to improve the looks and feel and/or aesthetics of the storage system 100. Further, in embodiments that include a display and/or a mirror, the lights 140 can improve visibility. Further, although described as being included in the lid, the lights 140 can be included in any suitable portion of the storage system 100.

Furthermore, the display 140/440 can be a smart and/or touch sensitive display that can receive instructions from a user and/or provide information to the user. As detailed below, with reference to FIG. 5, the display 140/440 can be coupled to a processor and configured to send and receive information and instructions to/from the processor.

FIG. 5 is a high-level block diagram of a system for storing items according to some embodiments disclosed herein, which illustrates examples of digital electronic circuitry and hardware 590 that can be used with, incorporated in, or fully or partially included in a storage system as disclosed herein. As shown, the electric circuitry 590 can include a processor 594 that is configured to monitor the operation of the storage system 500, send and/or receive signals regarding the operation of the storage system, and/or control the operation of the storage system. The digital circuitry can be included in any suitable position within the storage system. For example, the digital circuitry can at least partially be included on the storage system and/or on a separate system connected to the storage system (e.g., a smart phone or tablet connected to the system).

The processor 594 can be configured to collect or receive information and data regarding the storage system 510 and/or the one or more items 125a, 125b, 125c included in the compartments of the storage system 115a, 115b, 115c, and/or store or forward information and data to another portion of the storage system, such as the display 540. The processor 594 can further be configured to control, monitor, and/or carry out various functions needed for analysis, interpretation, display of information and data received from the housing 510. Generally, these functions can be carried out and implemented by any suitable computer system and/or in digital circuitry or computer hardware, and the processor 594 can implement and/or control the various functions and methods described herein.

The processor 594 can further be generally configured to monitor the operation of the storage system 510, send and/or receive signals regarding the operation of the storage system 510, and/or control the operation of the storage system 510. The processor 510 can also collect or receive data regarding the operation of the storage system 510 and/or store or forward the data to another entity (e.g., manufacturer of the items included in the compartments, etc.), or another system (e.g., a smart device such as a smart phone, a tablet, a computer, etc.).

The processor 594 can be connected to a main memory 591, and comprise a central processing unit (CPU) 595 that includes processing circuitry configured to manipulate instructions received from the main memory 591 and execute various instructions. The CPU 595 can be any suitable processing unit known in the art. For example, the CPU 595 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor.

Generally, the processor 594 and the CPU 591 can be configured to receive instructions and data from the main memory 595 (e.g., a read-only memory or a random access memory or both) and execute the instructions. The instructions and other data can be stored in the main memory 591. The processor 594 and the main memory 591 can be included in or supplemented by special purpose logic circuitry. The main memory 591 can be any suitable form of volatile memory, non-volatile memory, semi-volatile memory, or virtual memory included in machine-readable storage devices suitable for embodying data and computer program instructions. For example, the main memory 591 can comprise magnetic disks (e.g., internal or removable disks), magneto-optical disks, one or more of a semiconductor memory device (e.g., EPROM or EEPROM), flash memory, CD-ROM, and/or DVD-ROM disks.

The main memory 591 can comprise an operating system 592 that is configured to implement various operating system functions. For example, the operating system 295 can be responsible for controlling access to various devices, memory management, and/or implementing various functions of the storage system 150. Generally, the operating system 592 can be any suitable system software that can manage computer hardware and software resources and provide common services for computer programs.

The main memory 591 can also hold application software 593. The main memory 591 and application software 593 can include various computer executable instructions, application software, and data structures, such as computer executable instructions and data structures that implement various aspects of the embodiments described herein. For example, the main memory 591 and application software 593 can include computer executable instructions, application software, and data structures, such as computer executable instructions and data structures that implement an interactive system (e.g., an automated interactive system that allows virtual application of cosmetics, as detailed below), which can be employed to communicate with a user in order to, for example, display a selected item of cosmetic on the user's face.

Generally, the functions performed by the storage testing system 510 can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers).

The main memory 591 can also be connected to a cache unit (not shown) configured to store copies of the data from the most frequently used main memory 591. The program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

The processor 594 can further be coupled to a database or data storage 597. The data storage 597 can be configured to store information and data relating to various functions and operations of the storage system 510. For example, the data storage 597 can store data relating to the one or more items 125a, 125b, 125c stored in the compartments 115a, 115b, 115c. Further, in some embodiments, the database 597 can be configured to store information regarding events that may be of interest to the authorized party. For example, as detailed below, the database 597 can be configured to store information regarding most frequently selected and tested items, items that have been marked as favorites by the user, etc.

The processor 594 can further be coupled to a display 540 (e.g., display 140 shown in FIG. 1). The display 540 can be configured to receive information and instructions from the processor. The display 540 can generally be any suitable display available in the art, for example a Liquid Crystal Display (LCD) or a light emitting diode (LED) display. For example, the display 540 can be a smart and/or touch sensitive display that can receive an image of the user, provide information regarding products and items 125a, 125b, 125c included in the compartments 115a, 115b, 115c to the user, and receive and updated images to the user.

The processor 594 can further be connected to various interfaces. The connection to the various interfaces can be established via a system or an input/output (I/O) interface 596 (e.g., Bluetooth, USB connector, audio interface (e.g., speaker), FireWire, interface for connecting peripheral devices, etc.). The I/O interface 596 can be directly or indirectly connected to the storage system 510.

The processor 594 can further be coupled to a communication interface 598, such as a network interface. The communications interface 598 can be a communications interface that is configured to provide the storage system 510 with a connection to a suitable communications network 560, such as the Internet. Transmission and reception of data, information, and instructions can occur over the communications network 560. Further, in some embodiments, the communications interface 598 can be an interface that is configured to allow communication between the digital circuitry 590 (e.g., a remote computer) and the storage system 510 (e.g., via any suitable communications means such as a wired or wireless communications protocols including WIFI and Bluetooth communications schemes).

FIG. 6 illustrates a high-level block diagram of a compartment 615 according to some embodiments disclosed herein. As shown, each compartment 615 can include at least one sensor 618 configured to obtain some identifying information regarding the item 625 received in the compartment 615. For example, the sensor 618 can be an RFID or barcode reader configured to read a barcode or RFID tag 619 (e.g., passive RFID tag) on the item 625. The barcode can include any suitable information regarding the item 625, such as information regarding type, color, and texture of the item 625. Generally, any suitable sensing mechanism available in the art can be used. For example, the sensor 618 can comprise a reading sensor and/or a reading camera configured to identify the item 625.

Further, although described as having compartments 615 that are capable of receiving items 625 interchangeably, in some implementations, at least one compartment 615 can be configured to receive a specific item 625. Specifically, the at least one compartment 615 can be pre-programmed to receive a specific item 625 (e.g., a specific shade of lipstick from a specific brand). In such implementations, the compartment may be configured without a sensor and be configured to function based on the pre-programed information.

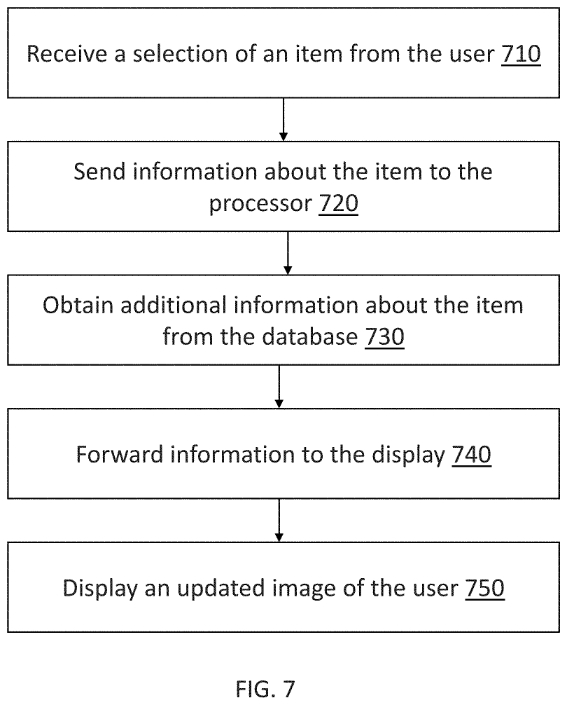

FIG. 7 is a flow diagram of some of the procedures that can be carried out by the interactive storage system 100 according to some embodiments disclosed herein. As noted, the storage system 100 can contain one or more items 125a, 125b, 125c in its various compartment. The procedures carried out by the storage system 100 can be initiated by a user 101, who selects an item 125a from among the items included in the storage system 100 (box 710). The user 101 can select the item 125a in various manners. For example, in some implementations, a user 101 can touch the item 125a such that the item 125a is actuated within its respective compartment 115a. The actuation of the item 125a can activate a sensor 618 (FIG. 6) included in the compartment 115a and trigger the sensor 618 to read information included on the item 125a. For example, as shown in FIG. 6, the sensor 618 can be configured to read the information included on a barcode 619 of the item 625 upon actuation of the item 625 within the compartment 615.

Generally, the selection of the item 125a can be made using any suitable scheme known in the art. For example, the user can use an application software interface on his/her smart phone and/or an application software interface on a display screen (e.g., tablet) at the location where the storage system is located (e.g., retail store) to identify the item 125a (e.g., using a name, number, or code assigned to the item 125a). The application software and the application software interface can include any suitable features known in the art. For example, the application software interface can be configured such that it receives information for configuring (e.g., initial configuration) the storage system from the user. Further, the application software can be configured to measure the statistics of a selection and forward that to other locations and/or interested parties (e.g., manufacturer). Generally, the storage system can be configured to function independent of the application software and/or in concert with the application software. The application software interface can also serve as a display for the storage system. Further, the application software can be configured to provide the user with a suggestion for an item to select, based on various factors, such as input received from the user (e.g., blue dress, nude color shoes, day casual function). For example, the application software interface can suggest a specific lip gloss for the user's specific input (e.g., wearing a blue dress) from the items that are available in the compartments of the storage system (e.g., among all lip glosses available in the box). In some implementations, the application software can comprise artificial intelligence (AI) learning abilities that allow the application software to learn the user preferences and use the learned information for providing the user with future suggestions.

Upon receiving the selection (box 720), the processor 594 (FIG. 5) analyzes the selection to obtain further information regarding the item 125a (box 730). For example, the processor 594 can access a database 597 that stores information about the item 125a to obtain the additional information. It should be noted that although shown as a local database, the database 597 can be a remote database, for example the database of a manufacturer of the item 125a to obtain the additional information about the item 125a.

The additional information can include any suitable information, such as brand, color, texture, shade, etc. of the selected item 125a and a location where the item should be applied. For example, if the item 125a is a lipstick, the processor 594 identifies the item as an item that should be applied to the user's lips.

The processor can forward the additional information to the display 140 for use in virtual application to the appropriate portion of the user's face (box 740). As noted, the display can be an interactive display 140 that displays an image of the user. The display 140 can display an initial image 141 of the user 101 before receiving the selection from the user. Upon receiving and processing a selection, the display can identify the appropriate portion of the user's face (e.g., the user's lips) and present an updated image of that portion using the additional information obtained on the selected item (box 750).

For example, in the graphical illustration shown in FIG. 1, the original image 141 is updated, upon selection of the first item 125a, to provide an updated image 141′, in which the user's lips appear in the color corresponding to the lipstick tube 125a contained in compartment 115a. Similarly, the original image 141 is updated, upon selection of the first item 125b, to provide an updated image 141″, in which the user's lips appear in the color corresponding to the lipstick tube 125b contained in compartment 115b. The original image 141 is also updated, upon selection of the first item 125c, to provide an updated image 141′″, in which the user's lips appear in the color corresponding to the lipstick tube 125c contained in compartment 115c. Generally, any image processing scheme known and available in the art can be used to display, process, and update the user's image.

The updated image 141′, 141″, 141′″ can be an image, in which the pixels corresponding to the relevant portion of the user's body have been updated. For example, the updated image 141′ can be an image in which the pixels corresponding to the user's lips have been updated to reflect the color of the item (lipstick) 125a selected by the user. Additionally or alternatively, the updated image can be a composite image, which includes a combination of the original image 141 and an image of the at least one item. For example, the at least one item can be an item of jewelry, such as a nose stud, and the updated image 141′ can be a composite image that includes the user's original image 141 combined with an image of the nose stud transposed on the relevant portion of the user's body (e.g., the curve of the user's nostril).

The foregoing is merely illustrative of the principles of the disclosure, and the apparatuses can be practiced by other than the described embodiments, which are presented for purposes of illustration and not of limitation.

Variations and modifications will occur to those of skill in the art after reviewing this disclosure. The disclosed features may be implemented, in any combination and subcombination (including multiple dependent combinations and subcombinations), with one or more other features described herein. The various features described or illustrated above, including any components thereof, may be combined or integrated in other systems. Moreover, certain features may be omitted or not implemented.

In general, embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter affecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program may correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Examples of changes, substitutions, and alterations are ascertainable by one skilled in the art and could be made without departing from the scope of the information disclosed herein. All references cited herein are incorporated by reference in their entirety and made part of this application.

1. A system for storing, identifying and selecting a cosmetic, comprising:
a housing configured to house a plurality of cosmetic items, the housing comprising a plurality of compartments each configured to house a respective cosmetic item;
one or more processors coupled to the housing;
a memory coupled to the one or more processors; and
one or more programs stored in the memory and configured to be executed by the one or more processors, the one or more programs including instructions that upon execution by the one or more processors:
receive a selection of at least one cosmetic item from a user; and
forward identification information regarding the at least one cosmetic item to a display screen configured to display an updated image showing the at least one cosmetic item applied to at least one portion of a face of the user.

2. The system of claim 1, wherein the housing is configured to house the display screen.

3. The system of claim 1, wherein the display screen is coupled to the housing via at least one of: a mechanical connection and a wireless connection.

4. The system of claim 1, wherein the plurality of cosmetic items include at least one of: lipstick, lip-color, lip-gloss, lip-liner, foundation, powder, eyeliner, eye shadow, cheek color, blush, and mascara.

5. The system of claim 1, wherein each of the plurality of compartments comprises at least one sensor configured to identify the cosmetic item housed in the compartment.

6. The system of claim 5, wherein the at least one sensor comprises at least one of: a barcode reader and an RFID chip reader configured to identify at least one of a barcode and an RFID chip of the cosmetic item housed in the compartment.

7. The system of claim 5, wherein the at least one sensor is configured to be activated in response to actuation of the cosmetic item within the compartment.

8. The system of claim 5, wherein the at least one sensor is configured to forward the identification information, obtained from identifying the cosmetic item, to the processor, and wherein the identification information indicates selection of the cosmetic item by the user.

9. The system of claim 1, wherein the identification information comprises at least one of: information indicating type of the at least one cosmetic item, information indicating at least one feature of the at least one cosmetic item, and information identifying the at least one appropriate portion of the face of the user.

10. The system of claim 9, wherein the at least one feature comprises at least one of: color, shade, texture, and tone of the at least one cosmetic item.

11. The system of claim 9, wherein the at least one appropriate portion of the face of the user comprises at least one of: cheeks, eyelids, lips, forehead, and neck of the user.

12. The system of claim 1, wherein the plurality of compartments are configured to at least one of: removably house the plurality of cosmetic items and interchangeably house the plurality of cosmetic items.

13. (canceled)

14. The system of claim 1, wherein the cosmetic item comprises at least one jewelry item.

15. The system of claim 1, wherein the display screen comprises a digital mirror.

16. The system of claim 1, further comprising a lid configured to removably close and seal the housing.

17. The system of claim 16, wherein the lid comprises an internal surface configured to house the display screen.

18. The system of claim 16, wherein the lid comprises at least one LED lamp disposed on internal perimeter thereof.

19. The system of claim 16, wherein the lid further comprises a camera configured to obtain an image of the user for display on the display screen.

20. The system of claim 18, wherein the camera comprises a video camera configured to display a video of the user in real-time.

21. The system of claim 18, wherein the camera comprises a video camera configured to display a video of the user in real-time.
